(19) United States
(12) Patent Application Publication
(10) Pub. No.: US 2008/0096708 A1
(43) Pub. Date: Apr. 24, 2008

(54) DRIVE APPARATUS

(76) Inventor: Ohannes Meguerditchian, Glendale, CA (US)

Correspondence Address: ITALIA IP, 3500 WEST OLIVE AVE., SUITE 300, BURBANK, CA, 91505, US

(21) Appl. No.: 11/558,909

(22) Filed: Nov. 11, 2006

Related U.S. Application Data
(63) Continuation-in-part of application No. 11/550,408, filed on Oct. 18, 2006.

(51) Int. Cl. F16H 7/00

(52) U.S. Cl. 474/148

(57) ABSTRACT

A drive apparatus for converting a substantially linear driving force to a rotary propulsive force where in apparatus comprises a pedal assembly for accepting a substantially linear drive force and a drive assembly for transferring the substantially linear drive force to a rotary motion through a power transference assembly linked to the pedal assembly and the drive assembly.

### BACKGROUND OF INVENTION

This application is a Continuation-in-Part of co-pending application Ser. No. 11/550,408 filed Oct. 18, 2006 and said application Ser. No. 11/550,408 is hereby incorporated by reference.

### BACKGROUND OF INVENTION

This application relates generally to a drive apparatus. More specifically, this application discloses a drive apparatus that converts a substantially linear driving force to a rotary propulsive force that may be used in a variety of applications such as to generate the propulsive force in a bicycle.

### SUMMARY

This application discloses a drive apparatus for converting a substantially linear driving force to a rotary propulsive force. The apparatus is of simple construction and can be used in a variety of applications including in standard bicycles, tricycles, reclining bicycles, personal watercraft such as paddle boats, scooters and any other similar transportation apparatus that uses a rotational force as a means to propel the transportation apparatus forward. The drive apparatus can also be uses in stationary exercise devises such at stationary bikes, stair climbers, and any devices that utilize a reciprocating substantially linear force as part of the exercise regimen.

In particular, this application discloses drive apparatus for converting a substantially linear driving force to a rotary propulsive force, said apparatus comprising pedal assembly means for accepting a substantially linear drive force; and a drive assembly means for transferring said substantially linear drive force to a rotary motion through a power transference means linked to said drive force accepting means and said drive assembly.

This application also discloses A drive apparatus for converting a substantially linear drive force to a rotary propulsive force, said apparatus comprising a frame; at least one pivot point located on said frame; a pedal assembly mechanically attached to said pivot point; a drive assembly located on said frame; and a power transference chain assembly mechanically connected to said pedal assembly and mechanically coupled to said drive assembly, and for mechanically connecting said pedal assembly to said drive assembly.

This application further discloses an improved bicycle drive apparatus of the type wherein bicycle pedals are driven by the feet of a rider for rotating at least one drive axle for the rotation thereof and the rotation of a pair of power sprockets coupled thereto for the propulsion of the bicycle in a forward direction, the improvement comprising means for mounting said pedals for receiving a substantially linear motion; means for transferring said substantially linear motion to a unidirectional rotary motion through a power transference means linked to each of said pedals; means for transferring said unidirectional rotary motion to at least one drive axle; and means for coupling said unidirectional motion of said at least one drive axle to a pair of power sprockets for propulsion of said bicycle.

### BRIEF DESCRIPTION OF THE DRAWINGS

The drawings, when considered in connection with the following description, are presented for the purpose of facilitating an understanding of the subject matter sought to be protected.

FIG. 1 is side plan view of a first embodiment of the drive apparatus disclosed herein incorporated on a scooter;

FIG. 2 is an enlarged, fragmentary view of the first embodiment of the drive apparatus in FIG. 1;

FIG. 3 is an enlarged, fragmentary, perspective view of the first embodiment of the drive apparatus in FIG. 1;

FIG. 4 is a perspective view of a second embodiment of the drive apparatus disclosed herein incorporated on a bicycle;

FIG. 5 is an enlarged, fragmentary, perspective view of the second embodiment of the drive apparatus in FIG. 4;

FIG. 6 is a perspective view of a third embodiment of the drive apparatus disclosed herein incorporated on a bicycle;

FIG. 7 is an enlarged, fragmentary, perspective view of the third embodiment of the drive apparatus in FIG. 6;

FIG. 8 is an enlarged, fragmentary, perspective view of the third embodiment of the drive apparatus in FIG. 6 with the rear wheel to show the details;

FIG. 9 is a perspective view of a fourth embodiment of the drive apparatus disclosed herein incorporated on a bicycle;

FIG. 10 is an enlarged, fragmentary, perspective view of the fourth embodiment of the drive apparatus in FIG. 9;

FIG. 11 is an enlarged, fragmentary, perspective view of the fourth embodiment of the drive apparatus in FIG. 9 with the rear wheel removed to show the details;

FIG. 12 is side plan view of a fifth embodiment of the drive apparatus disclosed herein incorporated on a scooter;

FIG. 13 is an enlarged, fragmentary perspective view of the fifth embodiment of the drive apparatus in FIG. 12;

FIG. 14 is perspective view of a sixth embodiment of the drive apparatus disclosed herein incorporated on a scooter;

FIG. 15 is an enlarged, fragmentary perspective view of the sixth embodiment of the drive apparatus in FIG. 14;

FIG. 16 is perspective view of a seventh embodiment of the drive apparatus disclosed herein incorporated on a tricycle;

FIG. 17 is an enlarged, fragmentary perspective view of the seventh embodiment of the drive apparatus in FIG. 16 with a rear wheel removed to show the details;

FIG. 18 is an enlarged, fragmentary perspective view of the seventh embodiment of the drive apparatus in FIG. 16 with a rear wheels removed to show the details;

FIG. 19 is perspective view of an eighth embodiment of the drive apparatus disclosed herein incorporated on a tricycle with a rear wheel removed to show the details;

FIG. 20 is a side plan view of a second embodiment of a pedal assembly with the first embodiment of the drive apparatus in FIG. 1 incorporated on a bicycle;

FIG. 21 is an enlarged, fragmentary perspective view of the second embodiment of a pedal assembly in FIG. 20;

FIG. 22 is an enlarged, fragmentary, perspective view of a first embodiment of the reciprocating assembly with the first embodiment of the drive apparatus in FIG. 1;

FIG. 23 is side plan view of a second embodiment of the reciprocating assembly with first embodiment of the drive apparatus in FIG. 1 disclosed herein incorporated on a bicycle; and

FIG. 24 is an enlarged, fragmentary view of the second embodiment of the reciprocating assembly in FIG. 23.

### DETAILED DESCRIPTION

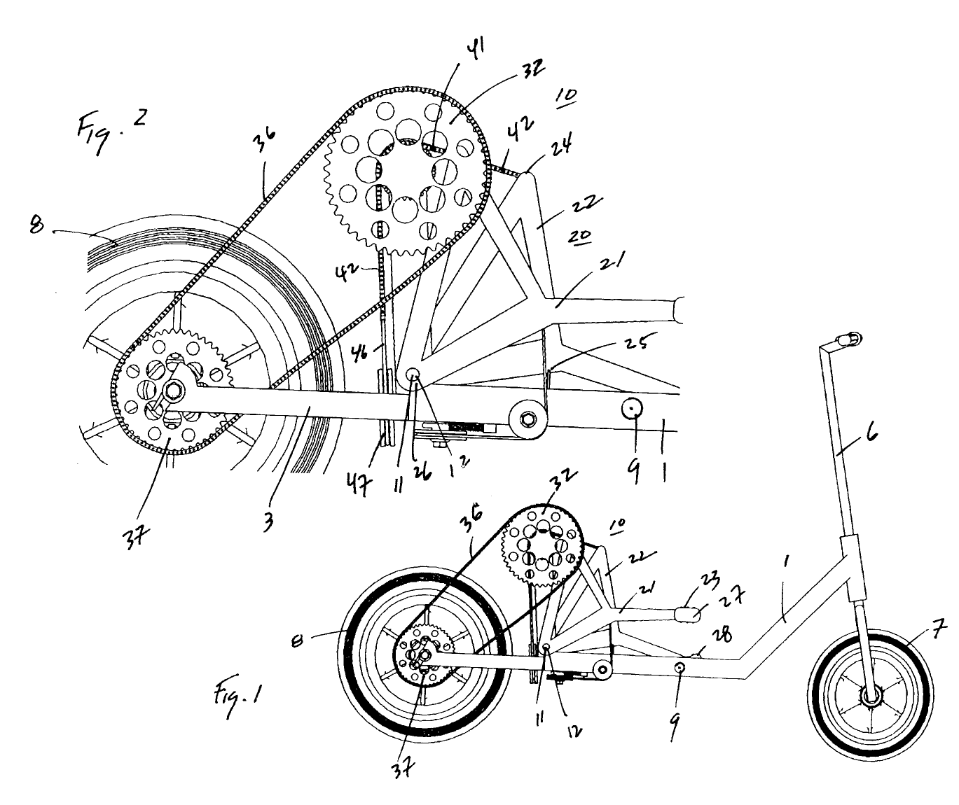

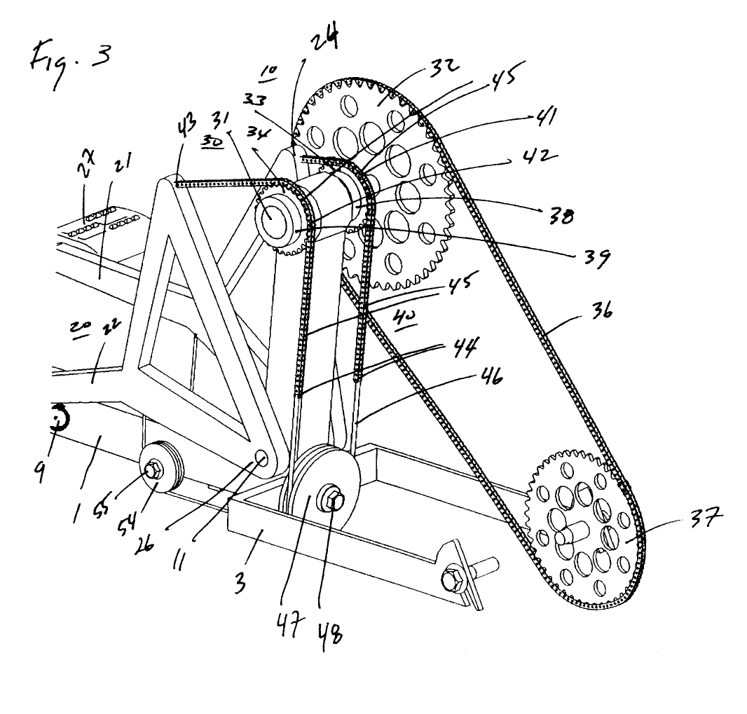

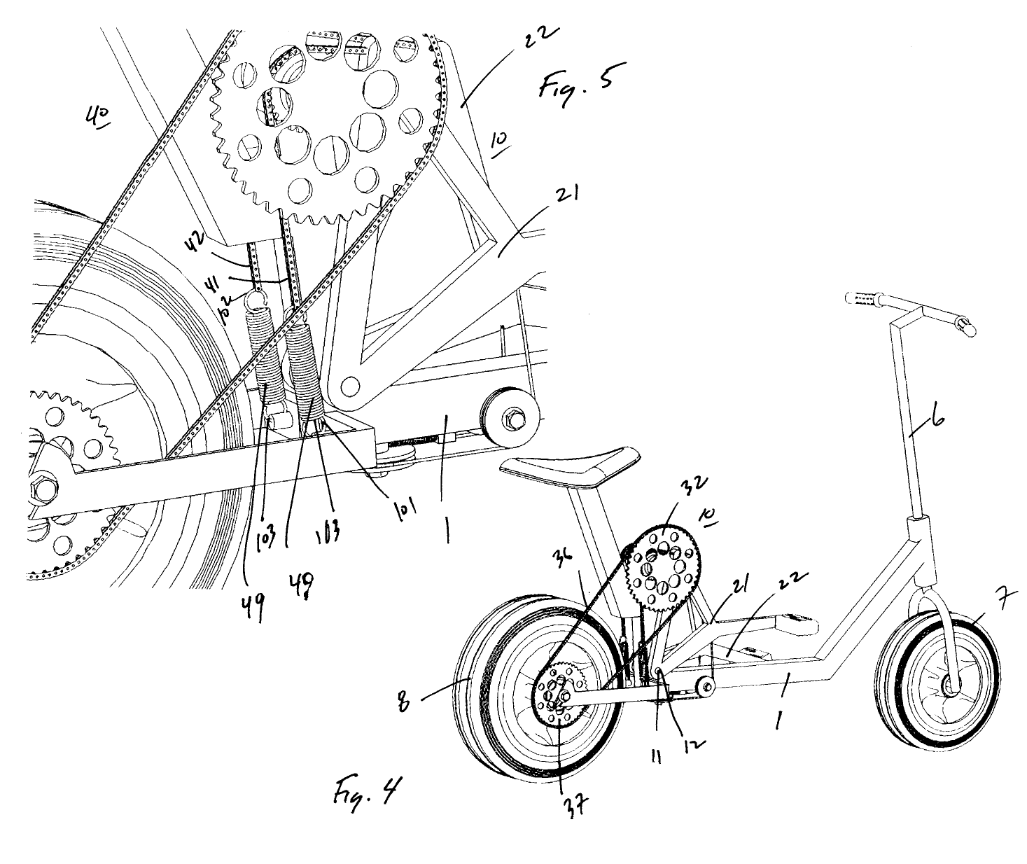

Referring to FIGS. 1-3, and specifically FIGS. 2 and 3, shown therein and generally designated by the reference character 10 is the first embodiment of the drive apparatus 10 constructed in accordance with the following description. For simplification of the following description, the various embodiments of the drive apparatus described herein can be generally described as falling into either a dual drive apparatus or a direct drive apparatus. The first embodiment of the drive apparatus 10 is an example of a dual drive apparatus and is shown incorporated in a scooter, however, it should be appreciated that the drive apparatus may be incorporated in a bicycle (as shown in subsequent figures), a tricycle (as shown in subsequent figures), a reclining bicycle or any other similar transportation device that utilizes a rider's “peddling” motion to propel the transportation device in a desired direction. Regardless of the nature of the transportation device, which are well known in the art, and shown for example purposes only, each is generally characterized by having a frame 1 that includes a front forks 2, rear forks 3, a seat 4, handle bars 6, and front 7 and rear 8 wheels. FIGS. 1-3.

Referring to FIGS. 1-3, the drive apparatus 10 includes a pivot point 11 located on said frame 1 that runs through the length of the frame for mechanical attachment of a the pedal assembly 20 such that the pedal assembly 20 can pivot about the pivot point 11. The attachment of the pedal assembly 20 may be mechanically attached to the pivot point 11 by means known in the art, such as a pivot axle 12. The pedal assembly 20 includes a first 21 and second pedal bracket 22 mechanically attached on opposite sides of the frame 1 and on opposite ends of said pivot axle 12. Not only can the pivot point for each pedal bracket 21 and 22 share the same pivot point 11 and pivot axle 12 as described above, it is also contemplated that pivot point for each pedal bracket 21 and 22 could be independent of each other such that each pedal bracket 21 and 22 has its own pivot axle 12 and whereby the pivot point 11 of each pedal bracket could be at the same or similar location on the frame 1. Each pedal bracket 21 and 22 includes a pedal attachment region 23 for attachment of pedals 27 and 28, a power transference chain attachment region 24, and a pivot attachment region 26 for attachment to said pivot point.

The drive apparatus 10 also includes a drive assembly 30 located on said frame 1. The drive assembly 30 includes a drive axle 31 positioned on the frame 1 that rotates within it. The drive assembly 30 also includes drive sprocket 32 rotationally mounted on the drive axle 31 such that when the drive axle 31 is rotated the drive sprocket 32 rotates. Also included in the drive assembly 30 is a first 33 and second 34 power sprocket rotationally mounted on the drive axle 31. The power sprockets are mounted on internal unidirectional clutches 38 and 39 which are in turn mounted on the drive axle 31. The unidirectional clutches 38 and 39 enable the drive axle 31 to turn when the power sprockets 33 and 34 are rotated in the proper direction (clockwise). See FIG. 3. A detailed explanation of the operation of the drive apparatus 10 is presented below.

The drive apparatus 10 also includes a power transference chain assembly 40 mechanically connected to said pedal assembly 20 and mechanically coupled to said drive assembly 30, and for mechanically connecting said pedal assembly 20 to said drive assembly 30. The power transference chain assembly 40 including a first 41 and second 42 power transference chain wherein each power transference chain 41 and 42 has a pedal attachment end 43, a flexible cable attachment end 44, and a power sprocket engagement region 45 there between. The power transference chain assembly 40 includes a flexible cable 46 fixedly attached by a clasp or other similar means between said power transference chains 41 and 42 at cable attachment ends 44. The power transference chain assembly 40 further includes and pulley 47 fixedly attached to a pulley axle 48 attached to said frame 1.

The power transference chain assembly 40 is then assembled by fixedly attaching the first power transference chain 41 to the first pedal bracket 21 at the power transference chain attachment region 24. Then, the first power transference chain 41 is mechanically coupled to the first power sprocket 33 at the power sprocket engagement region 45 and then fixedly attached to the flexible cable 46. The flexible cable 46 then engages the pulley 47 and continues and is fixedly attached to the second power transference chain 42. The second power transference chain 42 is then mechanically coupled to the second power sprocket 34 at the sprocket engagement region 45 and then fixedly attached to the second pedal bracket 22 at the power transference chain attachment region 24. As just described, the drive apparatus 10 forms a first closed loop such that when pedal 27 is pushed downward by the rider, pedal 28 will automatically rise and vise versa. As used herein, this motion is referred to as reciprocating. See FIGS. 2 and 3.

During operation of the drive apparatus 10 the following events take place in converting a substantially linear driving force to a rotary propulsive force. Referring to FIGS. 2 and 3, a first embodiment of the drive apparatus 10 is shown incorporated in a scooter where a rider places his or her feet on the pedals 27 and 28 attached respectively to the pedal brackets 21 and 22. The pedal brackets 21 and 22 act as a lever arms about pivot point 11 such that when the rider pushes down on the pedal 27, the foot travels downward in a substantially linear direction, in this example, a substantially vertical direction. As the pedals 27 and 28 reciprocate up and down, attached to their respective pedal brackets 21 and 22, the power transference chains 41 and 42 are driven along their loop. The power transference chains 41 and 42 engage the teeth of the power sprockets 33 and 34. The power sprockets 33 and 34 are mounted on unidirectional clutches 38 and 39, which, in turn, are mounted upon the drive axle 31. The unidirectional clutches 38 and 39 enable the drive axle 31 to turn when the power sprockets 33 and 34 are rotated in the proper direction (clockwise) by the power transference chains 41 and 42. Thus, when the first power transference chain 41 is rotated clockwise, e.g., the first pedal bracket 21 and attached pedal 27 is pushed down, the unidirectional clutch 38 is not engaged and allows the first power sprocket 33 to turn the drive axle 31. At the same time, the second pedal bracket 22 and attached pedal 28 is pushed up, which causes the second power sprocket 34 to rotate counter-clockwise, thereby engaging the unidirectional clutch 39 which prevents the power sprocket 34 from attempting to rotate the drive axle 31. Consequently, there is always a rotational force being applied to the drive axle 31 by either one of the power sprockets 33 or 34. In this way the drive sprocket 32 is turned and causes drive chain 36 to rotate a driven sprocket 37.

The following description of the first embodiment of the drive apparatus 10 is characterized as a dual drive apparatus for purposes of this application because of the role of the power sprockets 33 and 34 and the drive axle 31 acting to rotate a drive sprocket 32 which is then connected by a by a drive chain 36 to rotate a driven sprocket 37 and thereby generate the propulsive force. In contrast, and as more thoroughly described below, a direct drive apparatus is characterized by having the power sprockets act upon the drive axle and thereby directly generate the propulsive force.

The range of upward and downward motion of each pedal bracket can be as much as 180°, however a range of approximately 40° to approximately 60° is preferred, and a range of approximately 45° to approximately 55° is particularly preferred. The downward movement of the pedal brackets 21 and 22 may be terminated by a pair of pedal bracket stops 9 which are mounted on the frame 1. The pedal stops 9 may be rubber coated so at to provide a resilient and cushioned surface for the pedal brackets 21 and 22 to rebound off of. The pedal stops 9 may also have a hydraulic or gas-filled shock absorber nature to them to better absorb the downward force of the pedal brackets 21 and 22 and allow for a more efficient rebound of the pedal brackets 21 and 22 off the pedal stops 9 so that the impact on the rider is minimized.

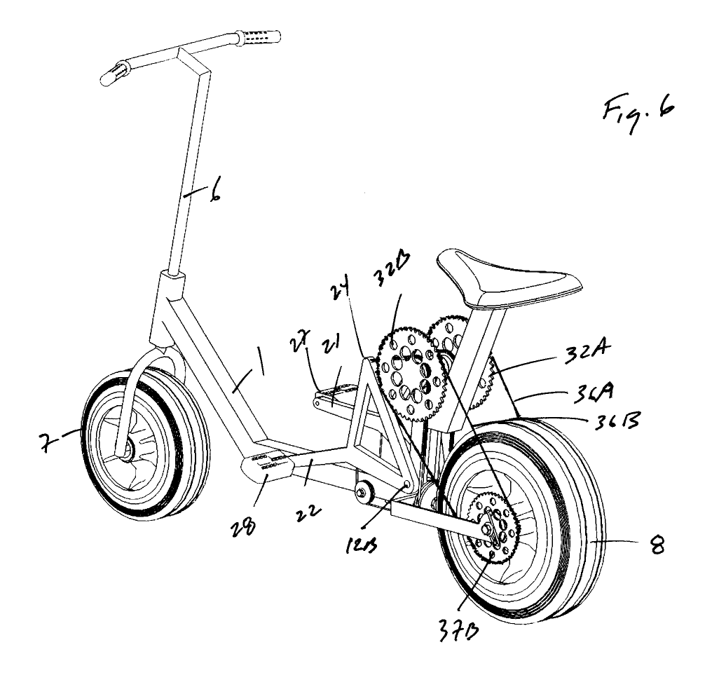

Referring to FIGS. 4 and 5, a second embodiment of the drive apparatus 10 is shown incorporated in a bicycle. This second embodiment of the drive apparatus is also an example of a dual drive apparatus. In this embodiment, the power transference chain assembly 40 is modified to include a pair of springs 49 rather than the flexible cable 46 and pulley 47. Each spring 49 includes a hook 101 at each end. A first end 102 of the spring 49 attaches to the power transference chains 41 and 42. The second end 103 of the spring 49 attaches to a spring attachment point on the frame 1. In this second embodiment of the drive apparatus 10, a closed loop is not formed and therefore the pedal brackets 21 and 22 act independently of one another, such that when one pedal bracket is pushed downward the other does not rise upward. As used herein, this motion is referred to as non-reciprocating. It should be appreciated that elastic or rubber bands, bungee chords or any other similar elastic material could be used in place of the springs.

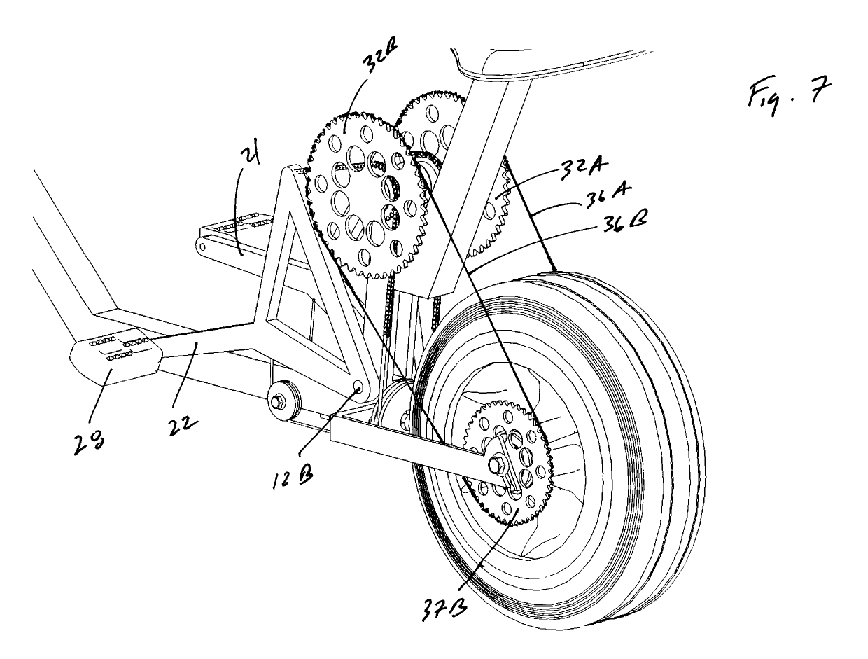

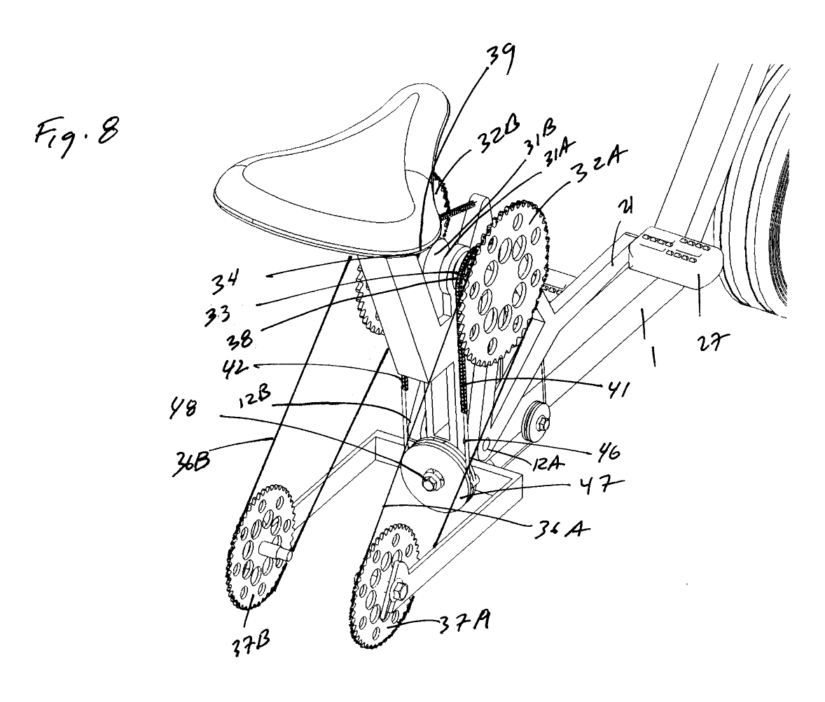

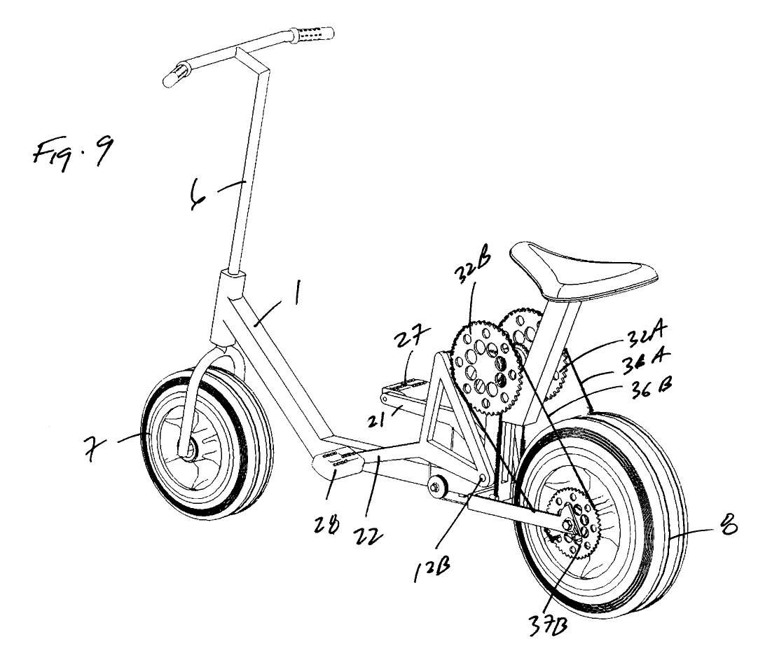

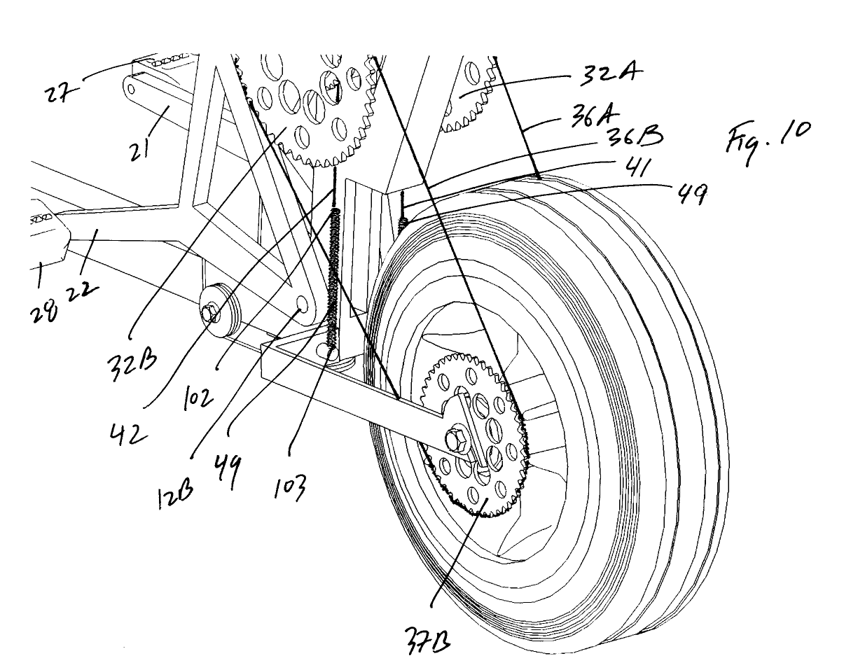

Referring to FIGS. 6-8, a third embodiment of the drive apparatus 10 is shown incorporated in a bicycle. This second embodiment of the drive apparatus is also an example of a dual drive apparatus. In this embodiment a portion of the frame is split which results in modifications to both the drive assembly 30 and pedal assembly 20. The pedal assembly 20 is modified wherein the pivot point 11 for each pedal bracket 21 and 22 is now independent of the other. Further, each pedal bracket 21 and 22 is attached at its own pivot axle 12A and 12B. The pivot point 11 of each pedal bracket could be at the same or similar opposite location on the frame 1. With respect to the modifications of the drive assembly 30, the drive axle 31 is split into two portions 31A and 31B and a pair of drive sprockets 32A and 32B are rotationally mounted at each end. Included then are power sprockets 33 and 34 rotationally mounted respectively on drive axles 31A and 31B. The power sprockets are mounted on internal unidirectional clutches 38 and 39 that are in turn mounted on the drive axles 31A and 31B.

The operation of this third embodiment of the drive apparatus 10 is similar to that described above for the first embodiment because of the closed loop created by utilizing the power transference chain assembly 40 described in the first embodiment. However, in this third embodiment the drive sprockets 32A and 32B are connected respectively to a pair of driven sprockets 37A and 37B through a pair of drive chains 36A and 36B.

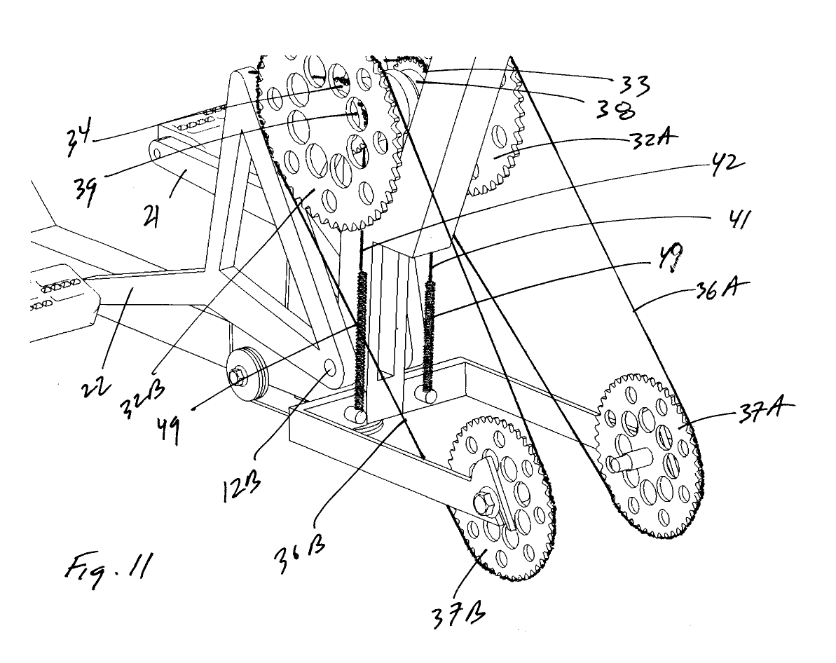

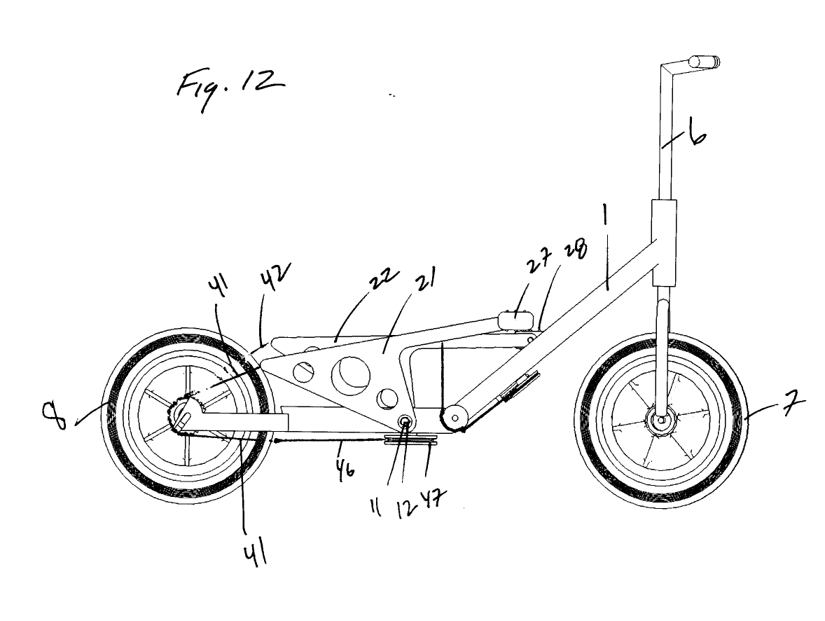

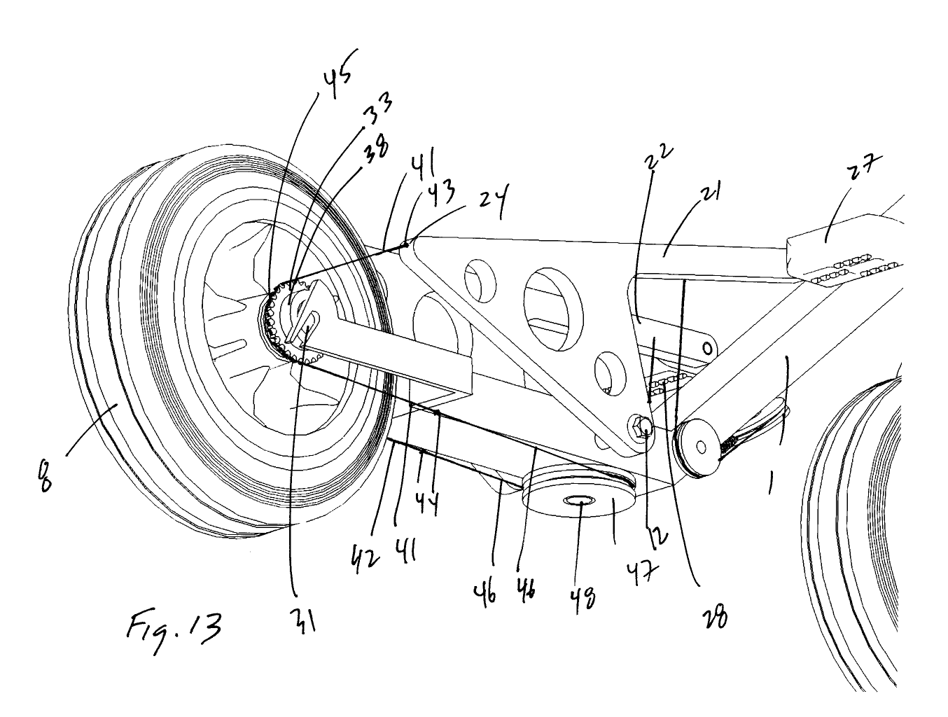

Referring to FIGS. 9-11, a fourth embodiment of the drive apparatus 10 is shown incorporated in a bicycle. This fourth embodiment of the drive apparatus is also an example of a dual drive apparatus. In this embodiment the drive apparatus described above in the third embodiment with the only difference being a modification of the power transference chain assembly 40. In this embodiment, the power transference chain assembly 40 is modified to include a pair of springs 49 rather than the flexible cable 46 and pulley 47 as described in the second embodiment. Each spring 49 includes a hook 101 at each end. A first end 102 of the spring 49 attaches to the power transference chains 41 and 42. The second end 103 of the spring 49 attaches to a spring attachment point on the frame 1. Again, as described above for the second embodiment of the drive apparatus 10, a closed loop is not formed and therefore the pedal brackets 21 and 22 act independently (non-reciprocating) of one another, such that when one pedal bracket is pushed downward the other does not rise upward. Again, it should be appreciated that elastic or rubber bands, bungee chords or any other similar elastic material could be used in place of the springs.

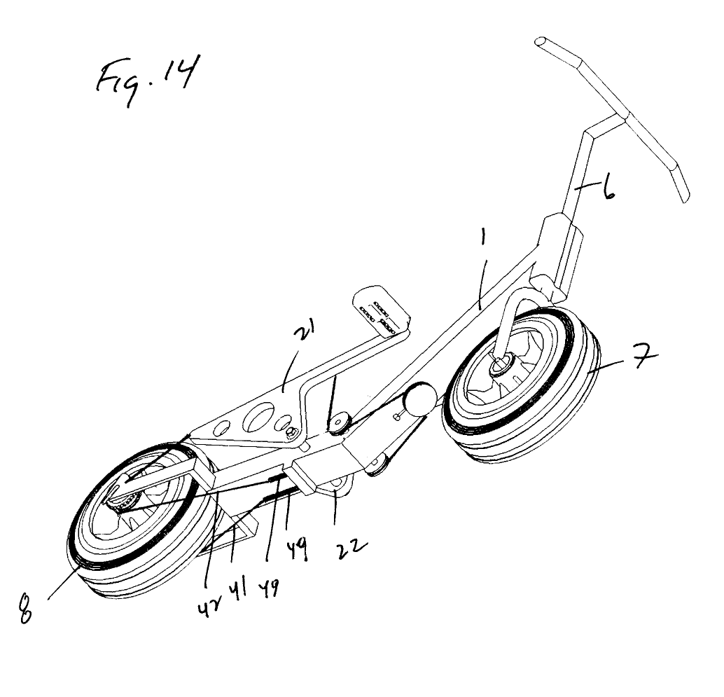

Referring to FIGS. 12 and 13, a fifth embodiment of the drive apparatus 10 is shown incorporated on a scooter. This fifth embodiment of the drive apparatus 10 is an example of a direct drive apparatus. A common characteristic of the direct drive apparatus embodiments is that there is no drive sprocket, drive chain, or driven sprocket as generally found in the above-described dual drive apparatus. Instead, a direct drive apparatus is characterized by having the power sprockets act upon the drive axle and thereby directly generate the propulsive force. Again, referring to FIGS. 12 and 13, the drive apparatus 10 the drive apparatus 10 includes a pivot point 11 located on said frame 1 that runs through the length of the frame for mechanical attachment of a the pedal assembly 20 such that the pedal assembly 20 can pivot about the pivot point 11. The attachment of the pedal assembly 20 may be mechanically attached to the pivot point 11 by means known in the art, such as a pivot axle 12. The pedal assembly 20 includes a first 21 and second pedal bracket 22 mechanically attached on opposite sides of the frame 1 and on opposite ends of said pivot axle 12. Not only can the pivot point for each pedal bracket 21 and 22 share the same pivot point 11 and pivot axle 12 as described above, it is also contemplated that pivot point for each pedal bracket 21 and 22 could be independent of each other such that each pedal bracket 21 and 22 has its own pivot axle 12 and whereby the pivot point 11 of each pedal bracket could be at the same or similar location on the frame 1. Each pedal bracket 21 and 22 includes a pedal attachment region 23 for attachment of pedals 27 and 28, a power transference chain attachment region 24, and a pivot attachment region 26 for attachment to said pivot point.

The drive apparatus 10 is modified from the first embodiment in that the drive assembly 30 is located on the rear wheel 8. The drive assembly 30 includes a drive axle 31 positioned within the wheel 8 such that when the drive axle 31 is rotated the wheel 8 rotates. Included in the drive assembly 30 is a first 33 and second 34 power sprocket rotationally mounted on the drive axle 31 on each side of the wheel 8. The power sprockets are mounted on internal unidirectional clutches 38 and 39 that are in turn mounted on the drive axle 31. The unidirectional clutches 38 and 39 enable the drive axle 31 to turn when the power sprockets 33 and 34 are rotated in the proper direction (clockwise).

The drive apparatus 10 of the fifth embodiment also includes a power transference chain assembly 40 mechanically connected to said pedal assembly 20 and mechanically coupled to said drive assembly 30, and for mechanically connecting said pedal assembly 20 to said drive assembly 30. The power transference chain assembly 40 including a first 41 and second 42 power transference chain wherein each power transference chain 41 and 42 has a pedal attachment end 43, a flexible cable attachment end 44, and a power sprocket engagement region 45 there between. The power transference chain assembly 40 includes a flexible cable 46 fixedly attached by a clasp or other similar means between said power transference chains 41 and 42 at cable attachment ends 44. The power transference chain assembly 40 further includes and pulley 47 fixedly attached to a pulley axle 48 attached to said frame 1.

The power transference chain assembly 40 is then assembled by fixedly attaching the first power transference chain 41 to the first pedal bracket 21 at the power transference chain attachment region 24. Then, the first power transference chain 41 is mechanically coupled to the first power sprocket 33 at the power sprocket engagement region 45 and then fixedly attached to the flexible cable 46. The flexible cable 46 then engages the pulley 47 and continues and is fixedly attached to the second power transference chain 42. The second power transference chain 42 is then mechanically coupled to the second power sprocket 34 at the sprocket engagement region 45 and then fixedly attached to the second pedal bracket 22 at the power transference chain attachment region 24. As just described, the drive apparatus 10 forms a first closed loop such that when pedal 27 is pushed downward by the rider, pedal 28 will automatically rise (reciprocating).

During operation of the fifth embodiment of the drive apparatus 10 the following events take place in converting a substantially linear driving force to a rotary propulsive force. Referring to FIGS. 12 and 13, an example of a direct drive apparatus is shown incorporated in a scooter where a rider places his or her feet on the pedals 27 and 28 attached respectively to the pedal brackets 21 and 22. The pedal brackets 21 and 22 act as a lever arms about pivot point 11 such that when the rider pushes down on the pedal 27, the foot travels downward in a substantially linear direction, in this example, a substantially vertical direction. As the pedals 27 and 28 reciprocate up and down, attached to their respective pedal brackets 21 and 22, the power transference chains 41 and 42 are driven along their loop. The power transference chains 41 and 42 engage the teeth of the power sprockets 33 and 34. The power sprockets 33 and 34 are mounted on unidirectional clutches 38 and 39, which, in turn, are mounted upon the drive axle 31. The unidirectional clutches 38 and 39 enable the drive axle 31 to turn when the power sprockets 33 and 34 are rotated in the proper direction (clockwise) by the power transference chains 41 and 42. Thus, when the first power transference chain 41 is rotated clockwise, e.g., the first pedal bracket 21 and attached pedal 27 is pushed down, the unidirectional clutch 38 is not engaged and allows the first power sprocket 33 to turn the drive axle 31. At the same time, the second pedal bracket 22 and attached pedal 28 is pushed up, which causes the second power sprocket 34 to rotate counter-clockwise, thereby engaging the unidirectional clutch 39 which prevents the power sprocket 34 from attempting to rotate the drive axle 31. Consequently, there is always a rotational force being applied to the drive axle 31 by either one of the power sprockets 33 or 34. In this way the wheel 8 is turned and the propulsive force generated.

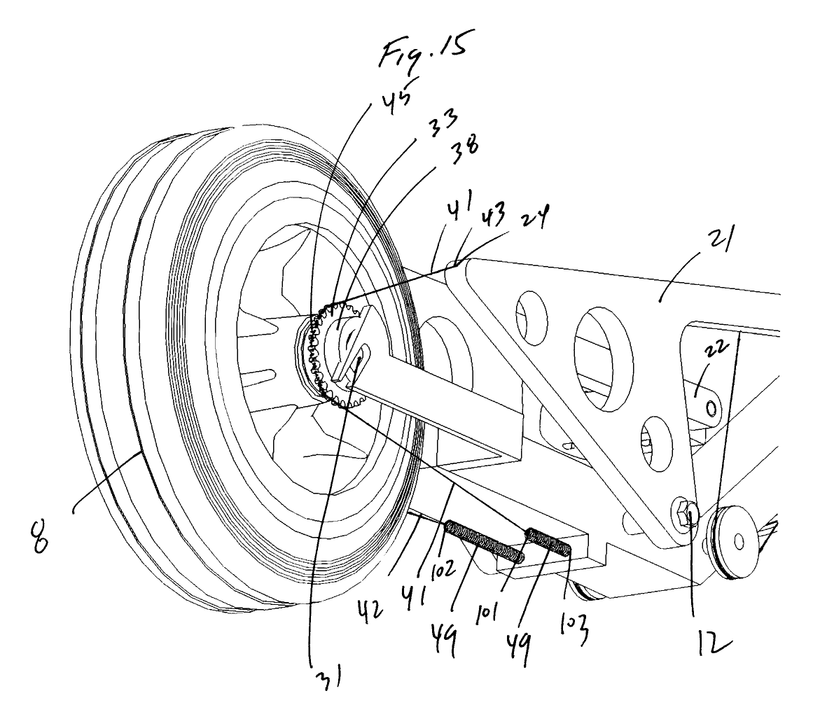

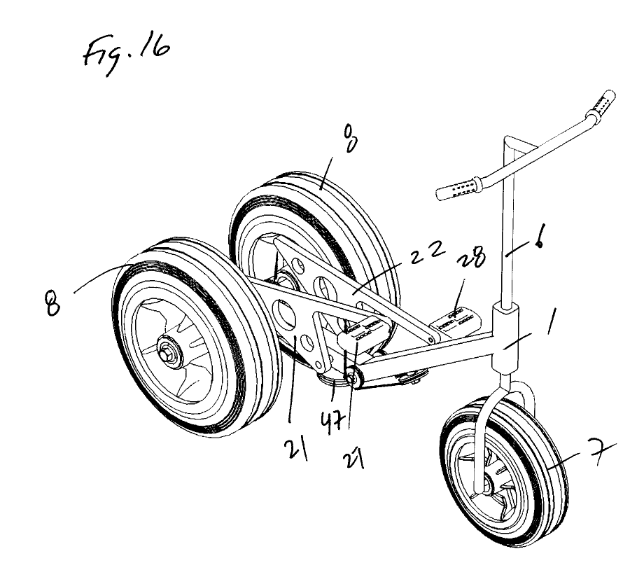

Referring to FIGS. 14 and 15, a sixth embodiment of the drive apparatus 10 is shown incorporated in a scooter. This sixth embodiment of the drive apparatus is also an example of a direct drive apparatus. In this embodiment, the power transference chain assembly 40 is modified to include a pair of springs 49 rather than the flexible cable 46 and pulley 47. Each spring 49 includes a hook 101 at each end. A first end 102 of the spring 49 attaches to the power transference chains 41 and 42. The second end 103 of the spring 49 attaches to a spring attachment point on the frame 1. In this second embodiment of the drive apparatus 10, a closed loop is not formed and therefore the pedal brackets 21 and 22 act independently (non-reciprocating) of one another, such that when one pedal bracket is pushed downward the other does not rise upward. It should be appreciated that elastic or rubber bands, bungee chords or any other similar elastic material could be used in place of the springs.

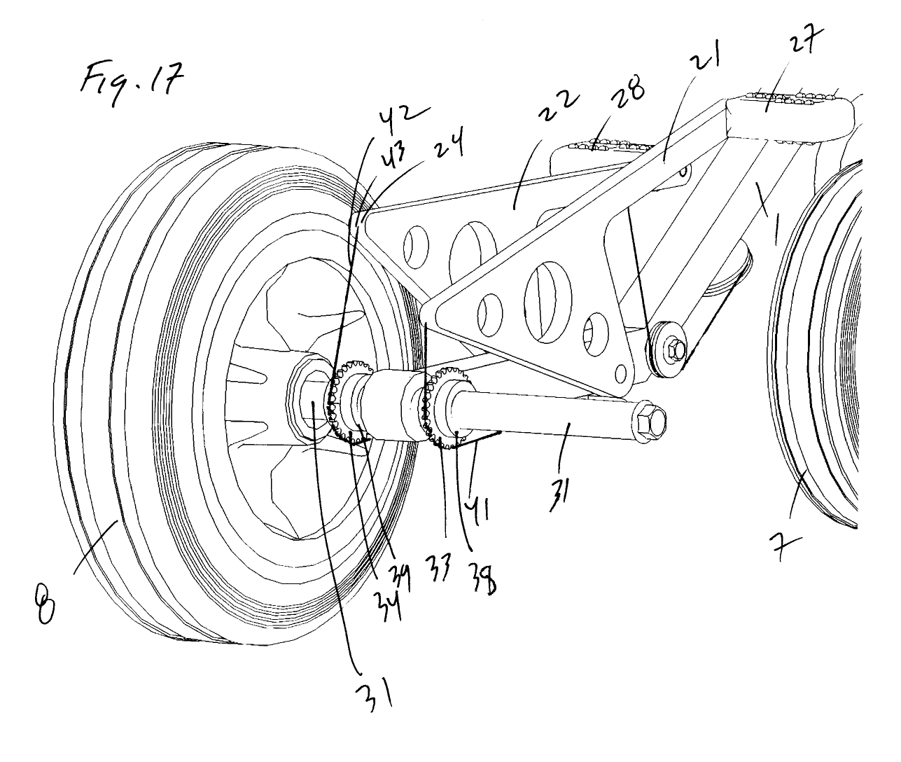

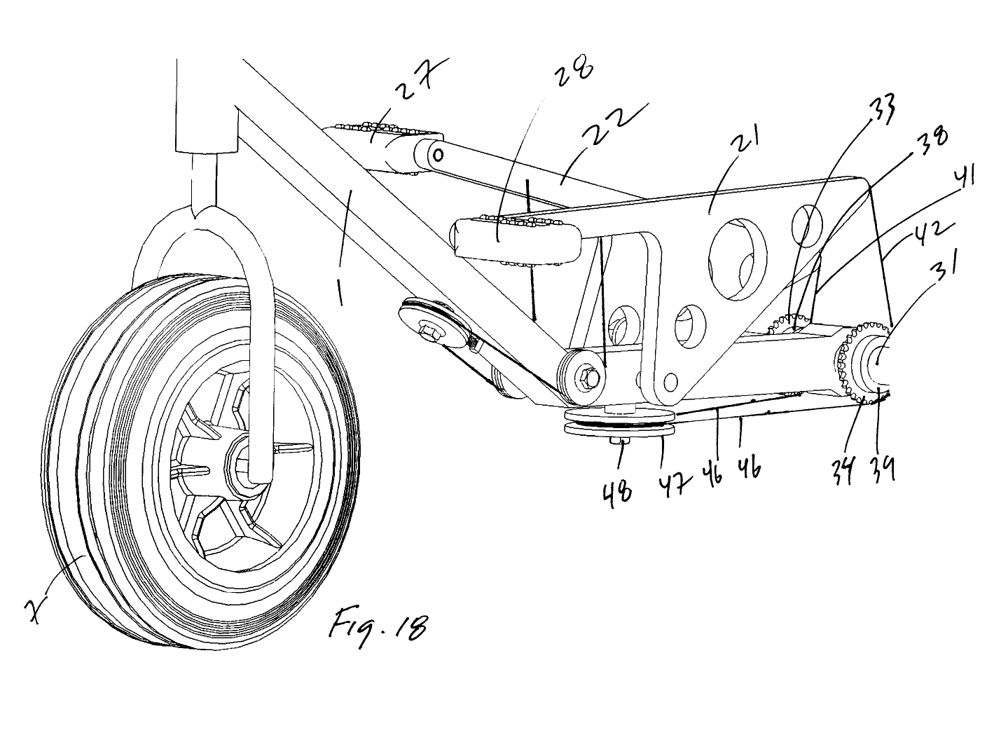

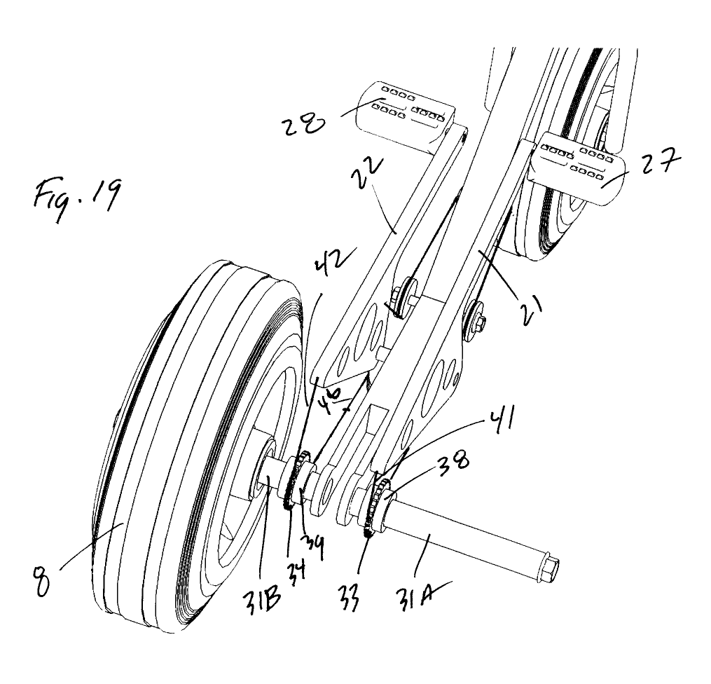

Referring to FIGS. 16-18, a seventh embodiment of the drive apparatus is shown incorporated in a three-wheeled scooter. This seventh embodiment of the drive apparatus is also an example of a direct drive apparatus. In this embodiment the drive assembly 30 is modified from the fifth in that the drive assembly 30 is located between the rear wheels 8. The drive assembly 30 includes a drive axle 31 positioned within the wheels 8 such that when the drive axle 31 is rotated, the wheels 8 rotate as one together. Included in the drive assembly 30 is a first 33 and second 34 power sprocket rotationally mounted on the drive axle 31 between the wheels 8. As in the fifth embodiment, the power sprockets are mounted on internal unidirectional clutches 38 and 39 that are in turn mounted on the drive axle 31. The unidirectional clutches 38 and 39 enable the drive axle 31 to turn when the power sprockets 33 and 34 are rotated in the proper direction (clockwise). Consistent with this direct drive apparatus of this embodiment, as described more fully above with the fifth embodiment, the power sprockets 33 and 34 act upon the drive axle 31 and thereby directly generate the propulsive force to the wheels 8. Although not shown, it should be appreciated given the preceding description, the power transference chain assembly 40 could be modified to include a pair of springs rather than the flexible cable 46 and pulley 47. Each spring would include a hook at each end. A first end of the spring would attach to the power transference chains 41 and 42. The second end of the spring would attach to a spring attachment point on the frame 1. In this embodiment of the drive apparatus 10, a closed loop would not be formed and therefore the pedal brackets 21 and 22 would act independently of one another, such that when one pedal bracket is pushed downward the other would not rise upward. It should be appreciated that elastic or rubber bands, bungee chords or any other similar elastic material could be used in place of the springs.

Referring to FIG. 19, an eighth embodiment of the drive apparatus 10 is shown incorporated in a three-wheel scooter. This eighth embodiment of the drive apparatus is also an example of a direct drive apparatus. In this embodiment a portion of the frame is split which results in modifications to the drive assembly 30. With respect to the modifications of the drive assembly 30, the drive axle 31 is split into two portions 31A and 31B and a pair of power sprockets 33 and 34 are rotationally mounted respectively on drive axles 31A and 31B. The power sprockets are mounted on internal unidirectional clutches 38 and 39 that are in turn mounted on the drive axles 31A and 31B.

The operation of this eighth embodiment of the drive apparatus 10 is similar to that described above for the seventh embodiment, however because of the split in the drive axle, the power sprockets 33 and 34 independently rotate their respective drive axles 31A and 31B such that the propulsive force generated alternates from rear wheel 8 to rear wheel 8. The eighth embodiment may utilize either the reciprocating mechanism (flexible cable and pulley) or the independent non-reciprocating mechanism (springs) as part of the power transference chain assembly 40 as is consistent in the previous descriptions.

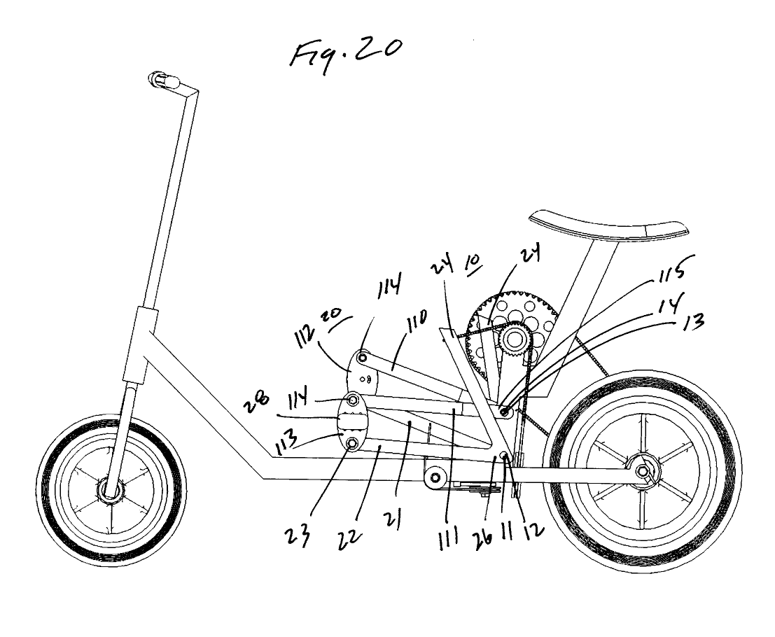

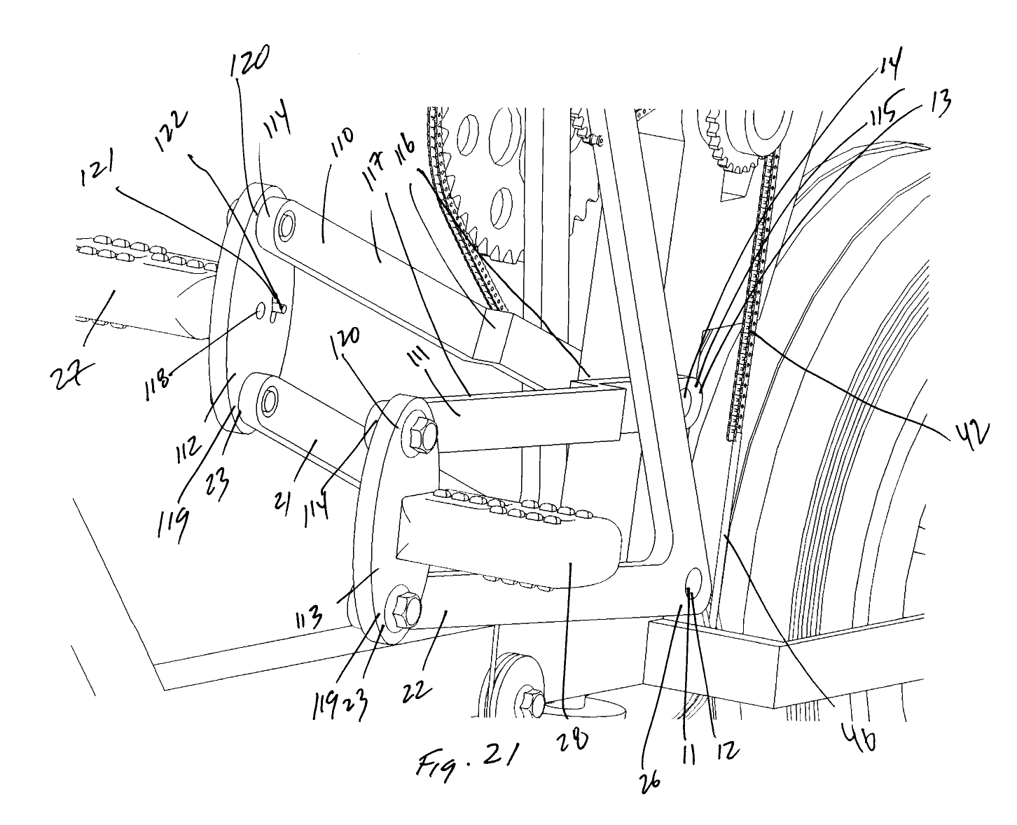

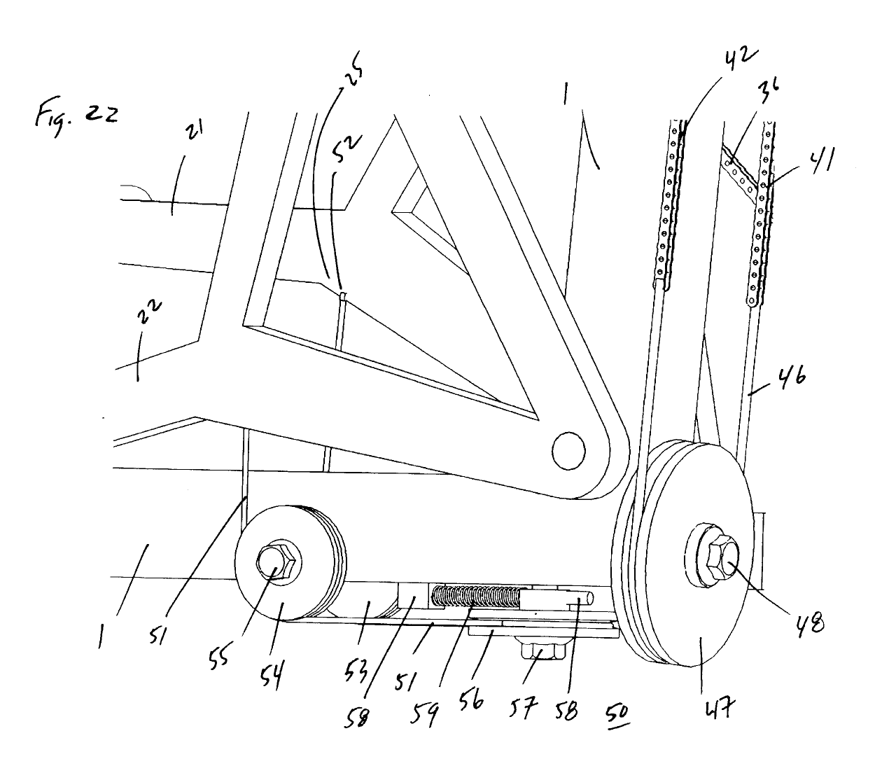

Referring now to FIGS. 20 and 21, a second embodiment of the pedal assembly 20 with the first embodiment of the drive apparatus 10 shown incorporated on a bicycle. In this second embodiment, the pedal assembly 20 includes first and second pedal brackets 21 and 22, first and second support brackets 110 and 111, and first and second pedal plates 112 and 113. The drive apparatus 10 includes a pivot point 11 located on said frame 1 where a pivot axle 12 runs through the length of the frame for mechanical attachment of the pedal bracket 21 and 22. A second pivot point 13 is also located on said frame 1 where a pivot axle 14 runs through the length of the frame for mechanical attachment of the support brackets 110 and 111. Each pedal bracket 21 and 22 includes a pedal plate attachment region 23 for attachment of the pedal plates 112 and 113, a power transference chain attachment region 24, and a pivot attachment region 26 for attachment to said pivot point 11 on said pivot axle 12. A spacer washer is mounted on the pivot axle 12 between the pedal brackets and the frame to create space between the bracket and the frame for mounting of the support brackets there between (not shown). Each support bracket 110 and 111 includes a pedal plate attachment region 114 for attachment of the pedal plates 112 and 113, a pivot attachment region 115 for attachment to said pivot point 13 on said pivot axle 14, and an offset portion 116 to allow for a portion 117 of the support brackets to extend on a parallel plane above the pedal brackets. Further, it is contemplated that not only can the pivot point 11 for each pedal bracket 21 and 22 share the same pivot point 11 and pivot axle 12 or the pivot point 13 for each support bracket 110 and 111 share the same pivot point 13 and pivot axle as described above, it is also contemplated that pivot point for each pedal bracket and support bracket could be independent of each other such that each pedal bracket and support bracket could have its own pivot axle and whereby the pivot point of each pedal bracket or support bracket could be at the same or similar location on the frame 1. Each pedal plate 112 and 113 includes a pedal attachment portion 118, for attachment of pedals 27 and 28, a pedal bracket attachment portion 119, and a support bracket attachment portion 120.

When the second embodiment of the pedal assembly is assembled such that 1) the distance between pedal plate attachment region 114, on the support brackets 110 and 111, and the support bracket pivot point 13 is substantially equal to the distance between the pedal plate attachment region 23, on the pedal brackets 21 and 22, and the pedal bracket pivot point 11, and 2) the distance between the pedal plate attachment region 114, on the support brackets 110 and 111, and the pedal plate attachment region 23 is substantially equal to the distance between the support bracket pivot point 13 and the pedal bracket pivot point 11, the pedal plate, and more specifically, the pedals 27 and 28 fixedly attached to the pedal attachment portions 118 will maintain a substantially constant angle relative to a horizontal plane, such as the ground, during the upward and downward motion of the pedals pedal assembly. Thus if the pedals 27 and 28 are mounted to the pedal plate in a way where the pedals are not free to rotate (as is well known in the art) the pedals will provide a stable platform for the rider where, even though the pedals travel is a substantially linear arc, the pedals would maintain a constant angle relative to a horizontal plane, such as the ground. Alternatively, the pedals 27 and 28 may be mounted to the pedal plates 112 and 113, according to the second embodiment of the pedal assembly 20, using the standard pivoting attachment means which allows the pedals to rotate freely while still providing a stable platform for the user. However, it is particularly preferred to modify the pedal plates 112 and 113 and pedals 27 and 28 to include a pin and groove assembly to provide a desired middle ground between the fixed pedal and the freely rotating pedal. In this version the pedal plates 112 and 113 include a groove portion 121 that mateably accepts a pin 122 extending from the pedals 27 and 28. The groove 121 prevents the pedal from freely rotating as with a standard pedal, but provides a partial range of motion when compared to when the pedal is nonrotatably attached to the pedal plates 112 and 113 as in version described above. This partial motion of the pin 122 and groove 121 assembly provides the stable platform when the rider is traversing a substantially horizontal surface, but also provides the pedal to move a few degrees up or down (about 5 to 15 degrees) when the rider is climbing or descending an inclined surface. This way the rider's feet are able to maintain a constant angle relative to the ground during operation of the transportation device (bicycle, scooter, etc.). The groove 121 may also include a rubber gasket (not shown) or any other like material attached within its surface so that the pin 122 is cushioned and thereby prevents it from rattling or coming to an abrupt stop when the pin engages the ends of the groove. It should be appreciated that the second embodiment of the pedal assembly 20 shown in FIGS. 20 and 21 associated with the first embodiment of the drive apparatus 10 would be readily adaptable to the other embodiments of the drive apparatus described herein.

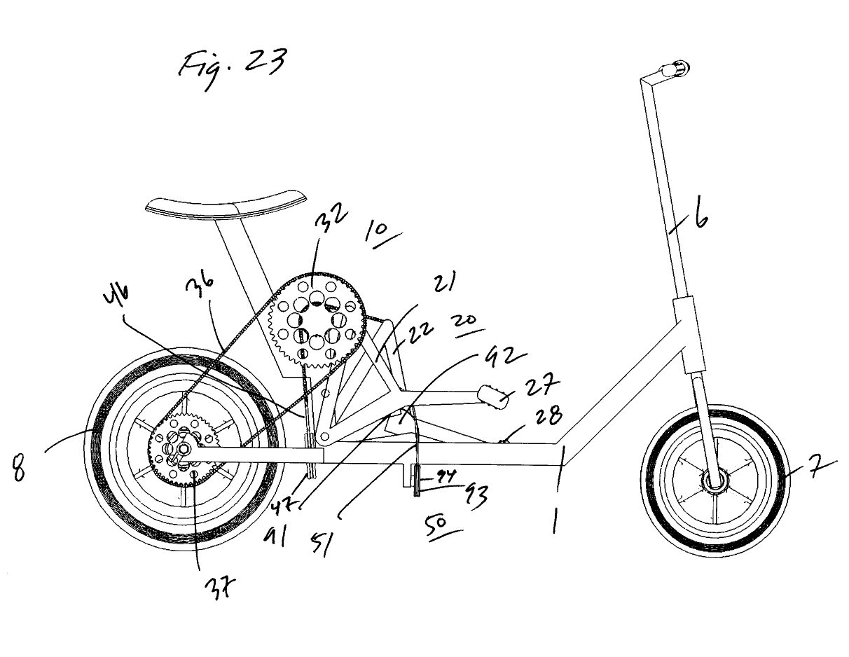

Referring to FIG. 22, the drive apparatus 10 may also include a first embodiment of a reciprocating assembly 50. The first embodiment of the reciprocating assembly 50 includes a reciprocating cable 51 with pedal attachment means 52 such as a screw at each end. The reciprocating assembly 50 also includes a first 53 and second 54 vertical pulley fixedly attached to a pulley axel 55 which is attached to the frame 1. The reciprocating assembly 50 also includes a horizontal pulley 56 fixedly attached to a pulley axle 57 attached to the frame 1. The reciprocating assembly 50 is assembled by attaching the reciprocating cable 51 to the first pedal bracket 21 at the cable attachment region 25. The flexible cable 51 then engages the first vertical pulley 53 and then continues on to engage the horizontal pulley 56, the second vertical pulley 54 before attaching to the second pedal bracket 22 at the cable attachment region 25. The reciprocating assembly 50 may also include a tensioning mechanism 58 mounted to the frame 1 and horizontal pulley 56, such as a high tension spring 59, screw (not shown), or any other similar mechanism, so that the horizontal pulley 56 is forced in direction away from the vertical pulleys 53 and 54 thereby maintaining the desired tension in the reciprocating cable 51. As just described, the reciprocating assembly 50 forms a second closed loop such that when pedal 27 is pushed downward by the rider, pedal 28 will automatically rise and vice versa. Likewise, when pedal 27 is pulled upward, pedal 28 will automatically go down and vice versa. This second closed loop acts to maintain the tension not only on the reciprocating cable, but also in the case of the embodiments that utilize the flexible cable 46 and pulley 47 mechanism as part of the drive apparatus 10, on the on the power transference chains 41 and 42 and the flexible cable 46. This helps to prevent the power transference chains 41 and 42 from releasing from the power sprockets 33 and 34 and/or the flexible cable 46 from releasing from the pulley 47 when a rider quickly dismounts from the drive apparatus 10 thereby causing a sudden change in the tension applied to such devices which can potentially overcome the first closed loop as described above.

The closed loop of the reciprocating assembly 50 also helps with the embodiments that utilize the springs 48 and 49 as part of the drive apparatus in that it helps to prevent the power transference chains 41 and 42 from releasing from the power sprockets 33 and 34. Additionally, with the embodiments that utilize the springs 48 and 49, the closed loop of the reciprocating assembly 50 allows the pedals to now reciprocate up and down.

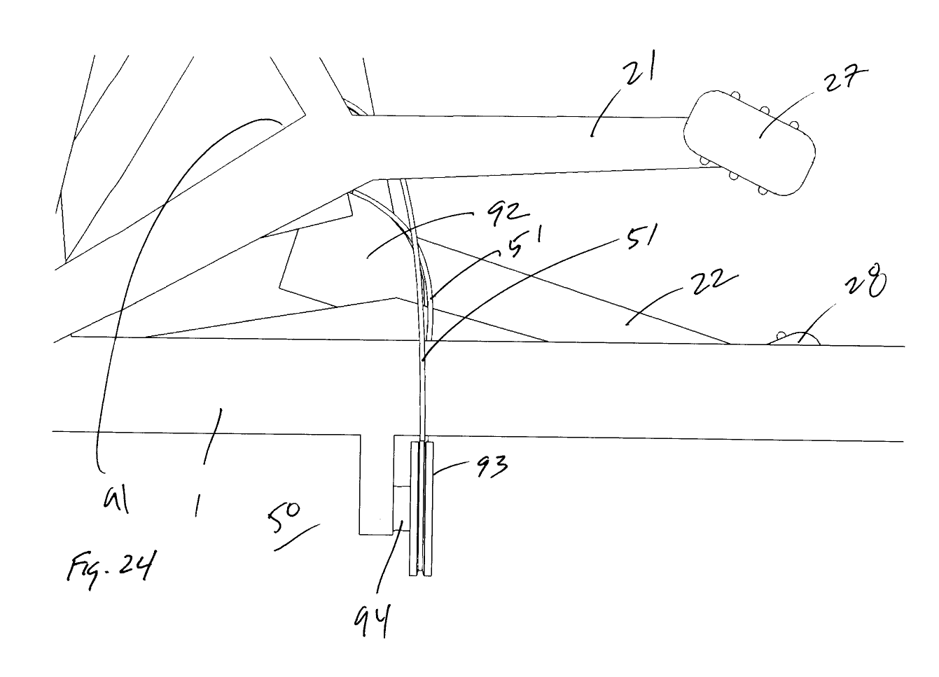

Referring to FIGS. 23 and 24, a second embodiment of the reciprocating assembly 50 is shown with the first embodiment of the drive apparatus 10 on a bicycle. The second embodiment of the reciprocating assembly 50 includes a reciprocating cable 51 with attachment means such as a screw at each end. The reciprocating assembly 50 also includes a first 91 and second 92 cable guides either fixedly attached to the pedal brackets 21 and 22 or incorporated into the pedal brackets themselves, and a vertical pulley 93 fixedly attached to a pulley axel 94 which is attached to the frame 1. The second embodiment of the reciprocating assembly 50 is assembled by attaching the reciprocating cable 51 to the first pedal bracket 21 at the cable guide 91. The flexible cable 51 then engages the first cable guide 91 such that as it descends from the guide 91 it is in position to engage the vertical pulley 93. The cable 51 continues and engages the second cable guide 92 such that is able to attach to the second pedal bracket 22 at the second cable guide 92. The second embodiment of the reciprocating assembly 50 may also include a tensioning mechanism mounted to the frame 1 and vertical pulley 93, such as a high tension spring, screw, or any other similar mechanism, so that the vertical pulley 93 is forced in direction away from the cable guides 91 and 92 thereby maintaining the desired tension in the reciprocating cable 51. As just described, the second embodiment of the reciprocating assembly 50 forms a second closed loop such that when pedal 27 is pushed downward by the rider, pedal 28 will automatically rise and vice versa. Likewise, when pedal 27 is pulled upward, pedal 28 will automatically go down and vice versa. This second closed loop acts to maintain the tension not only on the reciprocating cable 51, but also in the case of the embodiments that utilize the flexible cable 46 and pulley 47 mechanism as part of the drive apparatus 10, on the on the power transference chains 41 and 42 and the flexible cable 46. This helps to prevent the power transference chains 41 and 42 from releasing from the power sprockets 33 and 34 and/or the flexible cable 46 from releasing from the pulley 47 when a rider quickly dismounts from the drive apparatus 10 thereby causing a sudden change in the tension applied to such devices which can potentially overcome the first closed loop as described above.

The closed loop of the reciprocating assembly 50 also helps with the embodiments that utilize the non-reciprocating) springs 49 as part of the drive apparatus in that it helps to prevent the power transference chains 41 and 42 from releasing from the power sprockets 33 and 34. Additionally, with the embodiments that utilize the non-reciprocating springs 49, the closed loop of the reciprocating assembly 50 allows the pedals to now reciprocate up and down.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements. For example instead of the standard link chain common in the art for engaging the teeth of a sprocket as described above for both the power transference chains 41 and 42 and the drive chain 36, it should be understood that the disclosure includes the use of timing belts or other cables that would be able to similarly engage the teeth of a sprocket.

What is claimed is:

1. A drive apparatus for converting a substantially linear driving force to a rotary propulsive force, said apparatus comprising:
a pedal assembly means for accepting a substantially linear drive force; and
a drive assembly means for transferring said substantially linear drive force to a rotary motion through a power transference means linked to said pedal assembly means and said drive assembly means.

2. The apparatus of claim 1 wherein said power transference means is reciprocating.

3. The apparatus of claim 2 wherein the drive apparatus is a dual drive apparatus comprising at least one drive axle linked to at least one drive sprocket and means for coupling said rotary motion of said drive axle and said drive sprocket to at least one driven sprocket.

4. The apparatus of claim 3 wherein said pedal assembly means further comprises reciprocating means.

5. The apparatus of claim 4 wherein the pedal assembly means includes means for maintaining a substantially constant angle while accepting the substantially linear drive force.

6. The apparatus of claim 2 wherein the drive apparatus is a direct drive apparatus comprising at least one drive axle.

7. The apparatus of claim 6 wherein said pedal assembly means further comprises reciprocating means.

8. The apparatus of claim 7 wherein the pedal assembly means includes means for maintaining a substantially constant angle while accepting the substantially linear drive force.

9. The apparatus of claim 1 wherein said power transference means is non-reciprocating.

10. The apparatus of claim 9 wherein the drive apparatus is a dual drive apparatus comprising at least one drive axle linked to at least one drive sprocket and means for coupling said rotary motion of said drive axle and said drive sprocket to at least one driven sprocket.

11. The apparatus of claim 10 wherein said pedal assembly means further comprises reciprocating means.

12. The apparatus of claim 11 wherein the pedal assembly means includes means for maintaining a substantially constant angle while accepting the substantially linear drive force.

13. The apparatus of claim 9 wherein the drive apparatus is a direct drive apparatus comprising at least one drive axle.

14. The apparatus of claim 13 wherein said pedal assembly means further comprises reciprocating means.

15. The apparatus of claim 14 wherein the pedal assembly means includes means for maintaining a substantially constant angle while accepting the substantially linear drive force.

16. A drive apparatus for converting a substantially linear drive force to a rotary propulsive force, said apparatus comprising:
a frame;
at least one pivot point located on said frame;
a pedal assembly mechanically attached to said pivot point;
a drive assembly located on said frame; and
a power transference chain assembly mechanically connected to said pedal assembly and mechanically coupled to said drive assembly, and for mechanically connecting said pedal assembly to said drive assembly.

17. The apparatus of claim 16 wherein said power transference assembly is reciprocating.

18. The apparatus of claim 17 wherein said pedal assembly further comprises reciprocating means.

19. The apparatus of claim 18 wherein the drive apparatus is a dual drive apparatus comprising at least one drive axle linked to at least one drive sprocket and means for coupling said rotary motion of said drive axle and said drive sprocket to at least one driven sprocket.

20. The apparatus of claim 18 wherein the drive apparatus is a direct drive apparatus comprising at least one drive axle.

21. The apparatus of claim 17 wherein the pedal assembly includes means for maintaining a substantially constant angle while accepting the substantially linear drive force.

22. The apparatus of claim 16 wherein said power transference assembly is non-reciprocating.

23. The apparatus of claim 22 wherein said pedal assembly further comprises reciprocating means.

24. The apparatus of claim 23 wherein the drive apparatus is a dual drive apparatus comprising at least one drive axle linked to at least one drive sprocket and means for coupling said rotary motion of said drive axle and said drive sprocket to at least one driven sprocket.

25. The apparatus of claim 23 wherein the drive apparatus is a direct drive apparatus comprising at least one drive axle.

26. The apparatus of claim 22 wherein the pedal assembly includes means for maintaining a substantially constant angle while accepting the substantially linear drive force.

27. An improved bicycle drive apparatus of the type wherein bicycle pedals are driven by the feet of a rider for rotating at least one drive axle for the rotation thereof and the rotation of a pair of power sprockets coupled thereto for the propulsion of the bicycle in a forward direction, the improvement comprising:
means for mounting said pedals for receiving a substantially linear motion;
means for transferring said substantially linear motion to a unidirectional rotary motion through a power transference means linked to each of said pedals;
means for transferring said unidirectional rotary motion to at least one drive axle; and
means for coupling said unidirectional motion of said at least one drive axle to a pair of power sprockets for propulsion of said bicycle.
